(19) United States
(12) Patent Application Publication
(10) Pub. No.: US 2025/0350080 A1
(43) Pub. Date: Nov. 13, 2025

(54) SLIDING CONTACT MATERIAL FOR MOTOR BRUSH, MOTOR BRUSH, AND DIRECT CURRENT MOTOR

(71) Applicants: MABUCHI MOTOR CO., LTD., Matsudo-shi, Chiba (JP); TANAKA KIKINZOKU KOGYO K.K., Tokyo (JP)

(72) Inventors: Yasuhiro HASHIMOTO, Inzai-shi (JP); Hideyuki UZAWA, Inzai-shi (JP); Keiji NAKAMURA, Inzai-shi (JP); Kazutoshi YOSHIMURA, Inzai-shi (JP); Shunpei KAKIUCHI, Tomioka-shi (JP); Kentaro SATO, Oshu-shi (JP); Yoshinori HORIUCHI, Tomioka-shi (JP); Ryuta IDO, Oshu-shi (JP); Takao ASADA, Isehara-shi (JP); Masahiro TAKAHASHI, Tomioka-shi (JP)

(73) Assignees: MABUCHI MOTOR CO., LTD., Matsudo-shi, Chiba (JP); TANAKA KIKINZOKU KOGYO K.K., Tokyo (JP)

(21) Appl. No.: 18/722,805

(22) PCT Filed: Dec. 22, 2022
(86) PCT No.: PCT/JP2022/047317

§ 371 Date: Dec. 27, 2024

(30) Foreign Application Priority Data
Dec. 24, 2021 (JP) 2021-211066

(51) Int. Cl. H01R 39/20; C22C 32/00

(52) U.S. Cl. CPC H01R 39/20; C22C 32/0021

(57) ABSTRACT

The present invention is drawn to a sliding contact material for a motor brush, the sliding contact material containing: pure Ag as a matrix; and ZnO particles and Ta₂O₅ particles dispersed in the matrix, wherein the sliding contact material has a ZnO particle content of 0.1% by mass or more and 12% by mass or less and a Ta₂O₅ particle content of 0.1% by mass or more and 6.0% by mass or less. The present inventive sliding contact material is preferable as a constituent material of motor brushes of small DC motors, satisfactory in mechanical wear resistance and spark resistance, and superior in low-noise characteristics. In addition, the present invention is drawn to a sliding contact material that is capable of substituting for Ag—Pd-based alloys, which have become expensive because of the recent increase in palladium price.

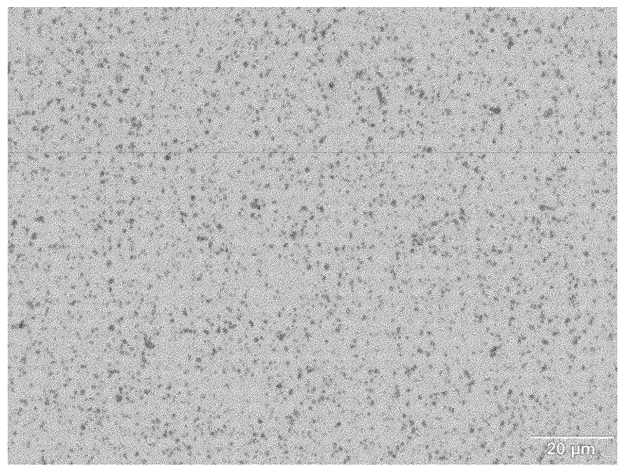

### CROSS-REFERENCE TO RELATED APPLICATIONS

The present application claims priority under 35 U.S.C. § 371 to International Patent Application No. PCT/JP2022/047317, filed Dec. 22, 2022, which claims priority to and the benefit of Japanese Patent Application No. 2021-211066, filed on Dec. 24, 2021. The contents of these applications are hereby incorporated by reference in their entireties.

### BACKGROUND OF THE INVENTION

### Field of the Invention

The present invention relates to a sliding contact material preferable as a constituent material of motor brushes of small DC motors, particularly to a sliding contact material that is superior in both wear resistance and spark resistance and Pd-free, thus being material-cost-friendly, and a motor brush with the sliding contact material.

### Description of the Related Art

Small DC motors have been widely used in a variety of fields such as automobiles, precision instruments, and home appliances, conventionally. For example, an automobile has many electric components installed such as an audio device, an air conditioner (air conditioner damper), electric folding mirrors, a steering lock pin, and automatic door locks, and small DC motors are used for driving them.

In addition, small DC motors are used as a main component of home appliances including shavers, electric toothbrushes, and small vacuum cleaners.

DC motors have a common basic structure and/or configuration even if they have different applications. A typical DC motor includes a casing, a permanent magnet placed on an inner surface of the casing, and a rotor rotatably supported by a shaft inside of the casing. The rotor includes an armature and a commutator, and a brush, which serves as a collector, is electrically connected to the commutator. The motor supplies power from an external power supply to the rotor via the brush and the commutator to rotate the rotor. An important factor for ensuring stable driving of such a DC motor is the durability of contact materials constituting the brush and the commutator. In particular, the brush is under a harsh environment in which the same part is continuously subjected to friction during driving the motor, and thus required to have durability to a higher degree than the commutator.

Selection of a contact material for a motor brush of a small DC motor depends on loads that the motor receives when being driven. The correlation between the stall torque and the stall current determines loads on the small DC motor. Motor brushes of high-load small DC motors with high stall torques and stall currents are subjected to high conduction currents, thus causing concerns over the occurrence of spark discharge and ark discharge when the brush separates away from the commutator, and are required to have durability to sparking wear. In addition, durability to mechanical wear is required as a property common to sliding contact materials. Carbon-based materials, which have low coefficients of dynamic friction to metal and are superior in mechanical wear characteristics, are typically used as a contact material for motor brushes that is capable of meeting those requirements for high-load small DC motors. Known as such carbon-based materials are materials obtained by mixing carbon powder with metal powder such as precious metal or copper powder or with ceramic powder (Patent Documents 1, 2). Moreover, a brush material in the form of a block of a carbon-based material having a large volume in the order of millimeters is used for compensating mechanical wear and sparking wear for motor brushes of high-load small DC motors. Motor brushes of high-load small DC motors typically have a structure in which a brush material in the form of a block is pressed onto a commutator via a spring. High-load small DC motors having such a structure are used for electric components of automobiles such as electric folding mirrors, steering locks, and automatic door locks.

On the other hand, motor brushes of low-load small DC motors with relatively low stall torques and stall currents cause fewer concerns over sparking wear due to discharge, and hence ensuring durability to mechanical wear is pursued for the motor brushes. Precious metal-based materials, in particular, Ag—Pd-based alloys are used as a contact material for motor brushes of low-load small DC motors. Examples of Ag—Pd-based alloys include a Ag-50% by mass Pd alloy and a Ag-30% by mass Pd alloy disclosed in Patent Document 3. Ag—Pd-based alloys have extremely high durability to mechanical wear, and furthermore are superior in welding resistance.

For motor brushes of low-load small DC motors, brush materials in each of which any of those precious metal-based materials is jointed to a base material including a copper-based material such as beryllium copper and phosphor bronze are used. In automotive applications, low-load small DC motors having such configuration are used for air-conditioning systems (HVAC) for vehicles such as air conditioner dampers, audio devices, and others. In addition, low-load small DC motors are used for universal motors to be installed in home appliances such as shavers and toys.

### PRIOR ART DOCUMENT

### Patent Document

### Patent Document 1

Japanese Patent Application Laid-Open No. Hei 11-4563

### Patent Document 2

Japanese Patent Application Laid-Open No. 2005-176492

### Patent Document 3

Japanese Patent Application Laid-Open No. Hei 5-277762

### SUMMARY OF THE INVENTION

### Technical Problem

The above sliding contact materials for motor brushes have been employed for various small DC motors, and used in different applications without causing any problem so far. However, increasing demand for small DC motors and needs for reduced product cost are forcing use of another type of constituent material for motor brushes for both high-load and low-load small DC motors.

For carbon-based materials that are used for motor brushes of high-load small DC motors, the primary reason for the material change is response to needs for down-sized motors. Carbon-based materials, which exhibit low minimum ark current values, are likely to allow the occurrence of spark discharge and ark discharge during the slide. So far, carbon-based materials have been used as a brush material in the form of a block for compensating not only mechanical wear but also sparking wear due to discharge. However, it is difficult to meet the need for down-sizing with brush materials in the order of millimeters.

Spark discharge and ark discharge, which are likely to occur on carbon-based materials, cause noise and rotation noise. In recent years, the automotive industry has been inclined to avoid noise during driving a motor partly because of increased preference for high-end products. Accordingly, a sliding contact material that is capable of substituting for carbon-based materials, superior in wear resistance, and satisfactory in spark resistance with less occurrence of spark discharge and the like has been demanded for high-load small DC motors.

On the other hand, the recent increase in Pd price has caused the necessity for material change for Ag—Pd-based alloys, which are contact materials for motor brushes of low-load small DC motors. Pd price used to be relatively low among precious metals, but has been rapidly increasing for the last two to three years, now being comparable to or higher than that of gold (Au). Ag—Pd-based alloys for motor brush applications include ones with Pd content ratios as high as 50% by mass, and hence Pd price has direct influence on the material cost of motor brushes. The increased material cost will also affect the product cost of motor brushes to be used in universal motors for home appliances.

Having extremely high durability to mechanical wear as described above, Ag—Pd-based alloys have incomparable properties as a sliding contact material.

However, the aforementioned problem of rapid increase in Pd price is promoting demand of a sliding contact material that does not exhibit as high durability as Ag—Pd-based alloys do but is Pd-free and well-balanced in cost and properties.

Although the above-described necessity for material change for both high-load and low-load small DC motors has been recognized, few specific attempts have been made for the necessity. In particular, the material cost problem has actually made such material change even more difficult. The present invention was made in view of such circumstances, and provides: a sliding contact material that is preferable as a constituent material of motor brushes of high-load small DC motors, satisfactory in durability to mechanical wear, and superior in spark resistance; and a low-cost sliding contact material that is also applicable to motor brushes of low-load small DC motors, and capable of substituting for Ag—Pd-based alloys.

### Solution to Problem

The present invention to solve the problems is drawn to a sliding contact material for a motor brush, the sliding contact material containing: pure Ag as a matrix; and Ta₂O₅ particles and ZnO particles dispersed in the matrix, wherein the sliding contact material has a Ta₂O₅ particle content of 0.1% by mass or more and 6.0% by mass or less and a ZnO particle content of 0.1% by mass or more and 12% by mass or less.

The present inventive sliding contact material for a motor brush includes a composite material in which metal oxide particles are dispersed in a matrix including Ag. The Ag constituting the matrix is a metal preferable in spark discharge properties with less occurrence of discharge even in high-load regions in contrast to carbon-based materials. Accordingly, the precious metal alloy made primarily of Ag in the present invention is deemed to be more satisfactory in spark resistance than conventional carbon-based materials. This results in successful achievement of resistance to sparking wear and reduction in noise, which is a problem concerned for carbon-based materials.

In the present invention, both the Ta oxide Ta₂O₅ and the Zn oxide ZnO are essentially contained as metal oxides in the form of dispersed particles in the Ag matrix. Examination conducted by the present inventors has concluded that Ta₂O₅ contributes to enhancement of wear resistance and spark resistance and ZnO to further enhancement of spark resistance. As described above, a brush in a DC motor is under a harsher environment than a commutator in terms of wearing and spark generation. A motor brush durable to the above-described harsh loads can be obtained by dispersing those two metal oxides in proper contents.

As described above, the present inventive sliding contact material for a motor brush achieves material reinforcement with dispersed metal oxide particles and enhanced spark resistance with an optimized configuration of the matrix and the metal oxides. These make the present inventive sliding contact material satisfactory in both durability to mechanical wear and that to sparking wear. The present inventive sliding contact material is a Pd-free precious metal alloy without inclusion of expensive Pd. Thus, the present invention is also useful as a sliding contact material for motor brushes that substitutes for Ag—Pd alloys. Hereinafter, the configuration of the present inventive sliding contact material for a motor brush will be described in more detail.

### (A) Configuration of and Production Method for Present Inventive Sliding Contact Material

(I) Ag matrix

The matrix of the present inventive sliding contact material for a motor brush is pure Ag. In terms of spark resistance, if a metal element other than Ag is mixed in the matrix, in other words, if the matrix is a Ag alloy, deteriorated spark properties result. Use of pure Ag as the matrix is an essential requirement for the present inventive contact material for a motor brush. Pure Ag is Ag containing no element other than Ag and inevitable impurities. Examples of such inevitable impurities include Fe, Cr, Pd, Cu, Ni, Mn, Al, Si, and Mg elements. Contamination with inevitable impurities is derived from trace amounts of elements contaminating Ag powder and metal oxide powder as raw materials of the sliding contact material and from constituent materials of a production apparatus (e.g., a crusher, a mixer). Elements that should be particularly restricted among the inevitable impurities are Fe, Cr, and Ni. This is because these particularly affect the spark resistance. The present inventive sliding contact material for a motor brush, as the whole material, preferably has an Fe/Cr/Ni total content of 0.3% by mass or less. The Fe/Cr/Ni total content is more preferably 0.2% by mass or less, and even more preferably 0.1% by mass or less.

### (II) Dispersed Particles (Metal Oxides)

In the present inventive sliding contact material for a motor brush, oxide particles of both ZnO and Ta₂O₅ are dispersed in the pure Ag matrix. The oxide particle contents are specified in present invention.

ZnO contributes to enhancement of spark resistance. In particular, for improved spark resistance, the present inventive sliding contact material for a motor brush contains ZnO in addition to Ta₂O₅. The ZnO content is 0.1% by mass or more and 12% by mass or less on the basis of the total mass of the sliding contact material. If the ZnO content is less than 0.1% by mass, the action is not expected to be exerted. ZnO contents more than 12% by mass result in deteriorated processability, leading to difficulty in processing into a specific shape for assembling a motor brush. The ZnO content is preferably 1% by mass or more and 9% by mass or less, and more preferably 2% by mass or more and 7% by mass or less.

Ta₂O₅ contributes to enhancement of wear resistance and spark resistance, and the Ta₂O₅ content is 0.1% by mass or more and 6.0% by mass or less on the basis of the total mass of the sliding contact material. If the Ta₂O₅ content is less than 0.1% by mass, the action is not expected to be exerted. Ta₂O₅ in an amount more than 6.0% by mass has difficulty in homogenously dispersing in the matrix and forms aggregates to cause increased contact resistance. Accordingly, the effect of enhancing spark resistance is not expected to be exerted. The Ta₂O₅ content is preferably 0.5% by mass or more and 3.0% by mass or less, and more preferably 0.9% by mass or more and 2.0% by mass or less.

The ZnO and Ta₂O₅ contents, which fall within the above ranges, can be measured simply by any of analysis methods including electron ray probe microanalysis (EPMA), energy-dispersive X-ray analysis (EDX), wavelength-dispersive X-ray analysis (WDX), and X-ray fluorescence analysis (XRF analysis).

The present inventive sliding contact material is jointed to a base material such as a Cu-based material to constitute a motor brush. If a part or the whole of the contact material can be separated from a base material, the oxide contents may be estimated from the metal component contents for Zn and Ta that have been measured through inductively coupled plasma atomic emission spectrometry (ICP atomic emission spectrometry) for a separated part of the material.

Regarding the particle sizes of the oxide particles, the average particle size of ZnO is preferably 0.5 μm or more and 5 μm or less, and that of Ta₂O₅ is preferably 0.5 μm or more and 5 μm or less. For both ZnO and Ta₂O₅, the effect of enhancing wear resistance is less exerted if the average particle size is less than 0.5 μm. If the average particle size of oxide particles is more than 5 μm, the oxide particles are sparsely dispersing and, as with the former case, less contribute to wear resistance. For determining an average particle size in the material, metal structure observation is performed with a SEM or the like to measure the particle sizes of oxide particles in an image by a biaxial method or the like, and the average value is calculated as the average particle size. In this case, if Ta₂O₅ and ZnO need to be distinguished from each other, it is appropriate to auxiliary apply elemental mapping by EPMA or the like.

The present inventive sliding contact material for a motor brush can be produced by powder metallurgy. In powder metallurgy, mixed powder of Ag powder for the matrix and Ta₂O₅ powder and ZnO powder for the dispersed particles is sintered, giving the contact material. Here, the average particle sizes of the Ag powder, the Ta₂O₅ powder, and the ZnO powder are preferably 1 μm or more and 15 μm or less, 0.5 μm or more and 5 μm or less, and 0.5 μm or more and 5 μm or less, respectively. It is more preferable to pressurize the mixed powder into a billet (compressed form) before sintering. It is preferable to pressurize the mixed powder at 2.5×10² MPa or more and 15×10² MPa or less in the billet production. The heating temperature in sintering is preferably 700° C. or more and 950° C. or less. The contact material including the sintered body obtained through the powder metallurgy can be processed as appropriate.

### (B) Form of Present Inventive Sliding Contact Material

The present inventive sliding contact material in assembling a motor brush may be in any form without limitation, and can be processed before use so as to have a shape and dimensions matched with the specification of a motor in which the motor brush is to be installed. However, the motor brush needs to keep contact with a commutator at a proper contact pressure, hence required to have springiness. Therefore, the present inventive sliding contact material is preferably combined with a base material having springiness and used in the form of a composite material. The base material is preferably a Cu-based material. Examples of the Cu-based material include pure Cu, nickel silver, beryllium copper, phosphor bronze, and CuNi alloys. The sliding contact material is jointed to at least a part of the base material including a Cu-based material, giving a composite material for a motor brush.

The present inventive sliding contact material costs less than Ag—Pd-based alloys but is expensive as compared with Cu-based materials. Thus, application of the composite material leads even to cost reduction for motor brushes. Moreover, a motor brush to which the composite material has been applied with selection of a base material having proper springiness enables down-sizing of motors. While carbon-based materials are applied to conventional high-load small DC motors and brushes including a carbon-based material in the form of a block and a spring material in combination are used for such motors, the present invention can provide smaller motors than them.

The composite material does not have any specifically limited dimensions. The sliding contact material in the form of a tape, a sheet, or a chip is jointed to a part or the whole surface of a base material in the form of a tape, a sheet or a chip. Various jointing methods including pressure welding (cladding), seam welding, and brazing can be applied to the jointing between the sliding contact material and the base material. The resulting composite material is then appropriately cut and/or processed to give a motor brush.

Motor brushes to which the present inventive contact material has been applied are applicable to the above-described high-load and low-load small DC motors. The configuration of small DC motors is as described above, and a motor brush and a commutator are essential for the configuration. The motor brush supplies power from a power supply outside of the motor to the commutator.

For motor brushes to which the present inventive sliding contact material is applied, Ag alloys are preferable as a constituent material of a commutator. Examples of such Ag alloys include a Ag alloy containing Ag with 1% by mass or more and 12% by mass or less in total of one or more of Pd, Cu, Zn, and Ni. Specific examples of such Ag alloys include a Ag—Cu alloy, a Ag—Cu—Ni alloy, and a Ag—Pd—Cu—Zn—Ni alloy.

Not only the mentioned Ag alloys (solid solution alloys), but also an oxide-dispersed Ag alloy as in the present invention may be used as a commutator material. An example is an oxide-dispersed Ag alloy in which MgO and ZnO are dispersed in a AgCu alloy matrix. Another example is an oxide-dispersed Ag alloy containing a Ag alloy (a Ag alloy containing one or more of Fe, Co, Ni, and Cu) as a matrix and Ta₂O₅ particles and Mg, Fe, Co, Ni, or Zn oxide particles dispersing in the matrix. The latter contact material for commutators, which allows Ta and Zn oxide particles to disperse therein, is similar to the present inventive contact material for a motor brush, but different therefrom in that a Ag alloy is applied as a matrix. The difference is because contact materials for motor brushes are required to have spark resistance at higher levels, as described above, and Ag alloys, which contain an additional element in the matrix, are unpreferable. The latter contact material for commutators, which contains a Ag alloy and Ta₂O₅ particles and other particles dispersing in the Ag alloy, is preferably used particularly for commutators of high-load small DC motors.

A configuration of the commutator material including a Ag alloy is applied in accordance with the specification of a low-load or high-load small DC motor. It is only required for a commutator of a small DC motor, irrespective of the application of the small DC motor, to include the above commutator material in the surface to be in contact with a motor brush. Accordingly, the commutator can be configured with a composite material, too, in which a base material is cladded with a contact material. In this case, the same Cu-based material as the above composite material for a motor brush can be used as the base material.

### Advantageous Effects of Invention

The present inventive sliding contact material has high wear resistance and spark resistance for application to motor brushes under a harsh operating environment with respect to mechanical wear and discharge and spark generation, and can exert the properties without use of Pd as a constituent metal. Having those improved features in terms of both performance and cost, the present inventive contact material is promising as one that substitutes for carbon-based materials that have been used for motor brushes of high-load small DC motors, and, furthermore, exhibits durability in combination with noise reduction effect.

The present inventive sliding contact material is also available for brushes of low-load small DC motors. While Ag—Pd alloys have been used as a motor brush material for such DC motors, the present invention is useful as an alternative material to Ag—Pd alloys. The present inventive contact material, for which no Pd is used in view of the recent increasing tendency of Pd price, allows universal motors and the like to be provided at low cost.

### BRIEF DESCRIPTION OF THE DRAWING

The FIGURE is a photograph showing the material structure of a sliding contact material (Ag-1.2% by mass Ta₂O₅-3.0% by mass ZnO) produced in First Embodiment.

### DETAILED DESCRIPTION OF THE PREFERRED EMBODIMENTS

First Embodiment: Preferred embodiments of the present invention will be described with examples shown below. In the present embodiment, a sliding contact material in which 1.2% by mass of Ta₂O₅ and 3.0% by mass of ZnO were dispersed in a pure Ag matrix, and a composite material including the sliding contact material were produced. Then, the composite material was processed into a motor brush, which was installed in a small DC motor, and the wear resistance was evaluated.

### [Production of Sliding Contact Material]

In the present embodiment, a sliding contact material was produced by powder metallurgy. Pure Ag powder (average particle size: 7 μm), 1.2% by mass of Ta₂O₅ powder (average particle size: 1 μm), and 3.0% by mass of ZnO powder (average particle size: 1 μm) were mixed with a ball mill for 5 hours. A cylindrical container was filled with that powder mixture, which was compressed by the application of a pressure of 5×10² MPa from the longitudinal direction to form a cylindrical billet of 50 mm in diameter. The cylindrical billet was then sintered through heating in the atmosphere at 850° C. for 4 hours. Those compression and sintering were repeated three times, giving a sliding contact material. This sliding contact material was hot-extruded into a coarse wire of 6 mm in diameter, which was repeatedly drawn and annealed, giving a wire rod of 1 mm in diameter. The wire rod was further rolled with a roller, giving a sliding contact material in the form of a tape. The Figure shows a photograph of the metal structure of the sliding contact material produced in the present embodiment.

### [Production of Composite Material for Motor Brush]

Subsequently, the sliding contact material in the form of a tape and a base material were jointed together by cladding (inlaying) to give a composite material. The base material used was nickel silver for springs (C7701). The cladding was performed with a roller, and the rolled material was subjected to a heat treatment at 750° C. to provide the composite material. The thickness of the sliding contact material in the composite material, which was to be processed into a motor brush, was 30 μm.

### Reference Example

In order to evaluate the durability of the sliding contact material (Ag-1.2% Ta₂O₅-3% ZnO) produced in the present embodiment, a composite material including a sliding contact material of a Ag-50% Pd alloy was produced as Reference Example. The reason why a Ag—Pd alloy was applied as Reference Example to serve as an evaluation reference is that the Ag—Pd alloy has very satisfactory wear resistance as described above, and that the Ag—Pd alloy is a precious metal-based contact material satisfactory also in terms of spark resistance, which is a key in use under high loads, and hence can serve as a reference for evaluation of spark resistance. With considering improvement in material cost, which is one of the objects of the present application, and the increased Pd price, the thickness of the Ag—Pd alloy of Reference Example was set to 10 μm so as to match the material costs. Then, the same base material as in the present embodiment was cladded with the Ag-50% Pd alloy, giving a composite material.

### [Production of Small DC Motor and Durability Test]

The composite materials produced in the present embodiment and Reference Example were processed into motor brushes, with which small DC motors were actually assembled, and durability test was carried out for the sliding contact materials under two sets of test conditions shown below. Commutators for the small DC motors were produced with composite materials in each of which a base material including a copper-based material was cladded with a contact material, wherein different contact materials were used for different test conditions.

Among the two sets of test conditions in the present embodiment, “Test Conditions 1” were ones simulating a low-load small DC motor to be used in an air-conditioning system (HVAC) for vehicles, and intended for evaluation of durability to mechanical wear. “Test Conditions 2” were ones simulating a high-load small DC motor to be used in an electric folding mirror in an automobile, and intended for evaluation of durability to sparking wear. In the durability test, an operation mode as a combination of counterclockwise rotation (CCW) and suspension (OFF) and clockwise rotation (CW) and suspension (OFF) was defined as one cycle, and the number of cycles until a motor broke down was evaluated.

TABLE 1

| | Test Conditions 1 | | Test Conditions 2 | |
|---|---|---|---|---|
| Voltage | DC 13.5 V | | | |
| Current | 83 | mA | 200 | mA |
| Load | 1.96 | mN-m | 2.0 | mN-m |
| Rotational frequency | 3400 | rpm | 7000 | rpm |

| | | |
|---|---|---|
| Commutator | AgCuZnNi | AgCuNi—Ta₂O₅ + ZnO |
| Mode | CCW 6 seconds - | CCW 3 seconds - |
| | OFF 2 seconds | OFF 5 seconds |
| | CW 6 seconds - | CW 3 seconds - |
| | OFF 2 seconds | OFF 5 seconds |

| | |
|---|---|
| Test environment | 25° C. 65% ± 20% RH |

The results of the durability test under the two sets of test conditions showed that Ag-1.2% Ta₂O₅-3% ZnO, which was the sliding contact material of the present embodiment, exhibited a durability of 683000 cycles under Test Conditions 1. For the Ag—Pd alloy as Reference Example, by contrast, the motor was found to break down after 473000 cycles. The evaluation test under Test Conditions 1 is one on the mechanical wear characteristics of a low-load motor for HVAC, etc., and the sliding contact material of the present embodiment has higher durability than the Ag—Pd alloy as Reference Example.

The evaluation results under Test Conditions 2 showed that motors did not break down even after 100000 cycles for both the Ag-1.2% Ta₂O₅-3% ZnO and the Ag—Pd alloy. Motors for electric folding mirrors are required to have a durability of 50000 cycles under Test Conditions 2 according to the standard, and those sliding contact materials were confirmed to have lifetimes two times or more longer than specified in the standard. The test under Test Conditions 2 is one for evaluating the spark resistance of a high-load small DC motor, and the Ag-1.2% Ta₂O₅-3% ZnO was confirmed to be superior in spark resistance. The Ag—Pd alloy as Reference Example is also deemed to be superior in spark resistance similarly to the present embodiment.

Thus, the evaluation test under the two sets of test conditions in the present embodiment confirmed that the Ag-1.2% Ta₂O₅-3% ZnO, which was the sliding contact material of the present embodiment, had preferable wear resistance and spark resistance even over the Ag—Pd alloy as Reference Example.

Second Embodiment: In the present embodiment, a plurality of sliding contact materials were produced with Ag—Ta₂O₅—ZnO having different Ta₂O₅ and ZnO contents, and evaluated for their durability. The sliding contact materials were produced by powder metallurgy as in First Embodiment. Here, the same pure Ag powder, Ta₂O₅ powder, and ZnO powder were used under the same production conditions as in First Embodiment to produce sliding contact materials (thickness: 30 μm) each including a Ag—Ta₂O₅—ZnO alloy, and motor brushes were produced with the sliding contact materials.

Each motor brush produced was then installed in the same small DC motor as in First Embodiment, and subjected to durability test. Durability to mechanical wear and that to sparking wear were checked also in the present embodiment, but the evaluation was performed by accelerated test under severe test conditions. Table 2 shows the test conditions in the present embodiment.

TABLE 2

| | Test Conditions 3 | | Test Conditions 4 | |
|---|---|---|---|---|
| Voltage | DC 12.5 V | | DC 13.5 V | |
| Current | 90 | mA | 160 | mA |
| Load | 0.78 | mN-m | 1.96 | mN-m |
| Rotational frequency | 7000 | rpm | 7000 | rpm |

| | | |
|---|---|---|
| Commutator | AgCuNi—Ta₂O₅ + ZnO | AgCuZnNi |

| | |
|---|---|
| Mode | CCW 6 seconds - OFF 2 seconds |
| | CW 6 seconds - OFF 2 seconds |
| Test environment | 25° C. 65% ± 20% RH |

The two sets of test conditions in the present embodiment were respectively ones simulating a low-load small DC motor for HVAC application. “Test Conditions 3” were ones primarily for evaluating mechanical wear, and the test was accelerated test with the rotational frequency increased from that of “Test Conditions 1” in First Embodiment. “Test Conditions 4” were ones primarily for evaluating spark resistance under increased electric loads, and the test was accelerated test with the rotational frequency and current increased from those of “Test Conditions 1” in First Embodiment. Table 3 shows the results of the durability test. Also in the present embodiment, a motor brush with a contact material (thickness: 10 μm) including a Ag-50% Pd alloy was prepared as Reference Example and subjected to the durability test. The results of the durability test are shown in Table 3.

TABLE 3

| | | Test | | Test | |
|---|---|---|---|---|---|
| | | Conditions 3 | | Conditions 4 | |
| | | (wear | | (spark | |
| | Composition | resistance) | | resistance) | |
| Example 1 | Ag—1.2Ta₂O₅—3ZnO | 110000 | cycles | 20000 | cycles |
| Example 2 | Ag—1.8Ta₂O₅—3ZnO | 159000 | cycles | 51000 | cycles |
| Example 3 | Ag—1.2Ta₂O₅—6ZnO | 110000 | cycles | 83000 | cycles |
| Example 4 | Ag—1.8Ta₂O₅—6ZnO | 151000 | cycles | 100000 | cycles |
| Reference | Ag—50Pd | 87000 | cycles | 9600 | cycles |

Example

*Example 1 is the contact material of First Embodiment.

The results of the durability test in the present embodiment confirmed that the Ag—Ta₂O₅—ZnO alloys of the examples were all superior in both wear resistance and spark resistance to the Ag—Pd alloy as Reference Example in the accelerated test under any set of the test conditions. Accordingly, the Ag—Ta₂O₅—ZnO alloys of the present embodiment enable production of high-durability sliding contact materials in combination with cost reduction due to being Pd-free.

Comparison among the contact materials of Examples 1 to 4 found enhancement of spark resistance by increase in either one of the Ta₂O₅ and ZnO contents. This suggested that Ta₂O₅ and ZnO each have an effect of improving spark resistance. Comparison on mechanical wear between Example 1 and Example 2 suggested that Ta₂O₅ has an effect of improving wear resistance. On the other hand, comparison between Example 2 and Example 4 found that increase in the ZnO content did not result in change in the number of cycles before breaking down, suggesting that ZnO has a weaker effect of improving mechanical wear. Nevertheless, having a proper ZnO content is essential for a contact material for motor brushes, ensuring wear resistance, under a harsh environment in terms not only of mechanical wear but also of sparking wear.

If the Ag-50% Pd alloy tested as Reference Example in First and Second Embodiments has the same thickness of a contact material as the Ag—Ta₂O₅—ZnO alloys of the present embodiment, the Ag-50% Pd alloy is expected to exhibit longer endurance time than in the present embodiment. The Ag—Pd alloy exhibits a very wide range of reinforcement by solid-solution strengthening. On the other hand, the present inventive Ag—Ta₂O₅—ZnO alloy has wear resistance enhanced by reinforced dispersion with metal oxide particles, but contains Ag, which is relatively soft, as a matrix, and hence the range of reinforcement is inferred to be narrower than that by solid-solution strengthening. However, the increased Pd price has made the Ag—Pd alloy unbalanced between cost and performance as described above. Being Pd-free, motor brush materials including the present inventive Ag—Ta₂O₅—ZnO alloy require significantly lower material cost than the Ag—Pd alloy. As shown in First and Second Embodiments, the Ag—Ta₂O₅—ZnO alloys of the present embodiment were confirmed to be very useful as an alternative material to the Ag—Pd alloy in view of material cost.

Third Embodiment: In the present embodiment, evaluation simulating a motor brush of a low-load universal small DC motor, which is used for shavers, etc., was carried out. In the present embodiment, the same Ag—Ta₂O₅—ZnO alloys as Examples 1 to 3 in Second Embodiment were produced by powder metallurgy. Then, a sliding contact material in the form of a tape and a base material were jointed together by cladding in the same manner as in Second Embodiment, giving a composite material (thickness: 30 μm). The base material used was beryllium copper (C1741). The composite material produced was processed into a motor brush, with which a small DC motor was assembled and subjected to durability test.

For comparison, durability test was carried out for two commercially available universal small DC motors. The commercially available small DC motors as comparative examples were one for high voltages and one for low voltages. The motor for high voltages included a motor brush material of a Ag-30% Pd alloy having a thickness of 5 μm, and the motor for low voltages included a motor brush material of a Ag-50% Pd alloy having a thickness of 5 μm. Also in the present embodiment, the thickness of the contact material including the Ag—Ta₂O₅—ZnO alloy (30 μm) was set so as to match the material cost with those of the contact materials of the comparative examples.

TABLE 4

| | For high voltages | | For low voltages | |
|---|---|---|---|---|
| Voltage | DC 3.4 V | | DC 1.1 V | |
| Current | 0.85 | A | 2 | A |

| | |
|---|---|
| Load | 1.27 mN-m |

| | | | | |
|---|---|---|---|---|
| Rotational frequency | 12500 | rpm | 10000 | rpm |

| | | |
|---|---|---|
| Commutator | AgPdCuZnNi | AgPdCuZnNi |

| | |
|---|---|
| Mode | CCW 2 minutes - OFF 2 seconds |
| Test environment | 25° C. 65% ± 20% RH |

TABLE 5

| | Brush material | For high voltages | For low voltages |
|---|---|---|---|
| Example 1 | Ag—1.2Ta₂O₅—3ZnO | 436 hours | 342 hours |
| Example 2 | Ag—1.8Ta₂O₅—3ZnO | 525 hours | — |
| Example 3 | Ag—1.8Ta₂O₅—6ZnO | 566 hours | — |
| Universal | Ag—30Pd | 352 hours | — |
| motor | Ag—50Pd | — | 169 hours |

It was confirmed from Table 5 that the small DC motors each including a motor brush material of any of the Ag—Ta₂O₅—ZnO alloys of Examples 1 to 3 exhibited operation times comparable to or longer than those of the universal motor for high voltages and that for low voltages as comparative examples, thus being satisfactory in durability. Also from the results in the present embodiment, the Ag—Pd alloy is expected to exhibit longer endurance time than the Ag—Ta₂O₅—ZnO alloys of the examples for the same contact material thickness. However, the evaluation carried out in the present embodiment was based on the concern about material cost, and confirmed from this viewpoint that the Ag—Ta₂O₅—ZnO alloys of the present embodiment are useful as an alternative material to the Ag—Pd alloy.

Fourth Embodiment: Here, motor brush materials were produced with other types of oxides to be dispersed in the Ag matrix, and their durability to sparking wear was evaluated. In the present embodiment, contact materials based on the Ag—Ta₂O₅—ZnO alloy of First Embodiment (Example 1) (Ta₂O₅: 1.2% by mass, ZnO: 3% by mass) with different amounts of Ta₂O₅, and those in which MgO or SnO was dispersed in place of ZnO were produced, and their durability when being installed in a small DC motor was evaluated. The contact materials were produced by powder metallurgy as in First Embodiment. For ZnO and SnO in producing mixed powder, ZnO powder and SnO powder each of 1 μm in particle size were used.

Composite materials were produced with the contact materials, and processed into motor brushes, with which small DC motors were assembled. Then, wear test was carried out under conditions shown below. The test conditions were ones simulating an automatic door lock in an automobile, and intended to primarily evaluate spark resistance.

TABLE 6

| | |
|---|---|
| Voltage | DC 13.5 V |

| | | |
|---|---|---|
| Current | 3 | A |

| | |
|---|---|
| Mode | CCW 0.1 seconds - OFF 2.4 seconds |
| | CW 0.1 seconds - OFF 2.4 seconds |
| Commutator material | AgCuNiMgZn |

| | | |
|---|---|---|
| Load | 50 | g-cm |

| | |
|---|---|
| Test environment | 298K, 50% RH |

In the wear test in the present embodiment, each motor operated for 100000 cycles in that mode was disassembled and the brush was taken out, and the wear depth was measured with a contact roughness meter (number of testing: 3). Table 7 shows the mean values of wear depth measured for the motor brush materials.

TABLE 7

| | Composition (% by mass) | | | | | |
|---|---|---|---|---|---|---|
| | Ag | Ta₂O₃ | ZnO | MgO | SnO | Wear depth |
| Example 1 | balance | 1.2 | 3.0 | — | — | 14 μm |
| Example 2 | balance | 1.8 | 3.0 | — | — | 16 μm |
| Example 5 | balance | 0.6 | 3.0 | — | — | 16 μm |
| Example 6 | balance | 0.6 | 5.0 | — | — | 15 μm |
| Comparative | balance | 1.2 | — | — | — | 18 μm |
| example 1 | | | | | | |
| Comparative | balance | 1.2 | — | 2.3 | — | 22 μm |
| example 2 | | | | | | |
| Comparative | balance | 1.8 | — | 2.3 | — | 25 μm |
| example 3 | | | | | | |
| Comparative | balance | 0.6 | — | 2.3 | — | 22 μm |
| example 4 | | | | | | |
| Comparative | balance | 1.2 | — | — | 3.0 | 22 μm |
| example 5 | | | | | | |
| Comparative | balance | 1.2 | — | — | 5.0 | 26 μm |
| example 6 | | | | | | |
| Comparative | balance | 1.2 | 3.0 | 2.3 | — | 22 μm |
| example 7 | | | | | | |
| Comparative | balance | 1.2 | 3.0 | — | 3.0 | 20 μm |
| example 8 | | | | | | |

As confirmed in Second Embodiment, among the oxides dispersing in the Ag matrix, Ta₂O₅ is deemed to primarily ensure the durability of the contact material to mechanical wear, and ZnO is deemed to have an effect of improving spark resistance. The results in the present embodiment (Table 7) showed that the contact materials in which a non-ZnO oxide (MgO, SnO) was dispersed were inferior in spark resistance to Example 1 and so on. The contact materials in which ZnO was contained but MgO or SnO was simultaneously dispersing did not have satisfactory spark resistance. This suggests that not all types of metal oxide should be dispersed. The present embodiment revealed that ZnO is preferable for enhanced durability to mechanical wear and sparking wear.

### INDUSTRIAL APPLICABILITY

The present inventive sliding contact material has wear resistance and spark resistance preferable for brushes of small DC motors, and exerts durability in combination with noise reduction effect. The present invention can be preferably applied to small DC motors in various fields including automotive applications, precision instruments, and home appliances. In automotive applications, the present invention can be applied to small DC motors in electric components such as audio devices, air conditioner dampers, electric folding mirrors, and automatic door locks. For home appliances, the present invention can be applied to small motors in shavers, electric toothbrushes, small vacuum cleaners, and so on.

1. A sliding contact material for a motor brush, the sliding contact material comprising: pure Ag as a matrix; and ZnO particles and Ta₂O₅ particles dispersed in the matrix, wherein
the sliding contact material has a ZnO particle content of 0.1% by mass or more and 12% by mass or less and a Ta₂O₅ particle content of 0.1% by mass or more and 6.0% by mass or less.

2. The sliding contact material for a motor brush according to claim 1, wherein the pure Ag as a matrix is pure Ag having an Fe/Cr/Ni total content of 0.3% by mass or less.

3. A composite material for a motor brush, the composite material comprising: a base material comprising a Cu-based material; and a sliding contact material jointed to at least a part of the base material, wherein the sliding contact material jointed is the sliding contact material defined in claim 1.

4. A motor brush for a DC motor, the motor brush comprising the composite material defined in claim 3.

5. A DC motor comprising: a motor brush; and a commutator herein the motor brush is the motor brush defined in claim 4.

6. A composite material for a motor brush, the composite material comprising: a base material comprising a Cu-based material; and a sliding contact material jointed to at least a part of the base material, wherein the sliding contact material jointed is the sliding contact material defined in claim 2.
